(19) United States
(12) Patent Application Publication
(10) Pub. No.: US 2006/0108928 A1
(43) Pub. Date: May 25, 2006

(54) Process for producing a supply conductor for a lamp, and supply conductor for a lamp, as well as lamp having a supply conductor

(75) Inventors: Bodo Mittler, Stadtbergen (DE); Manfred Weiss, Kissing (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/281,430

(22) Filed: Nov. 18, 2005

(30) Foreign Application Priority Data
Nov. 24, 2004 (DE) 102004056773.5

(51) Int. Cl. H01J 61/04; H01J 17/04

(52) U.S. Cl. 313/631

(57) ABSTRACT

The invention relates to a process for producing a supply conductor, which is at least partially provided with a coating containing at least one platinum metal, for a lamp, in which process at least two supply conductor parts are joined to one another by a welded or soldered join to produce the supply conductor, and in which process, according to the invention, before the welded or soldered join is produced, a metal powder suspension which contains the at least one platinum metal is applied to at least one of the supply conductor parts, so that the metal powder suspension is arranged in the region of overlap between the at least two supply conductor parts.

### I. TECHNICAL FIELD

The invention relates to a process for producing a supply conductor, which is at least partially provided with a coating containing at least one platinum metal, for a lamp, in which process at least two supply conductor parts are joined to one another by a welded or soldered join to produce the supply conductor and to a corresponding supply conductor, and also to a lamp having a supply conductor of this type.

### II. BACKGROUND ART

EP 1 111 655 A1 has disclosed a supply conductor for a lamp which comprises a sealing foil and a metal pin joined to it. The sealing foil is configured as a molybdenum foil which is at least partially provided with a coating containing ruthenium.

EP 1 465 236 A2 describes a discharge lamp with a discharge vessel which has at least one sealed end provided with a current leadthrough, with that section of the pin-like electrode which extends into the sealed end being provided with a coating which contains a metal from the platinum group, preferably ruthenium. The abovementioned section of the electrode is joined to a molybdenum foil.

### III. DISCLOSURE OF THE INVENTION

It is an object of the invention to provide an improved process for producing supply conductors of the generic type for lamps and corresponding supply conductors and lamps having supply conductors of this type.

The process according to the invention for producing a supply conductor, which is at least partially provided with a coating containing at least one platinum metal, for a lamp comprises welding or soldering at least two supply conductor parts; according to the invention, before the welding or soldering is carried out, a metal powder suspension which contains the at least one platinum metal is applied to at least one of the supply conductor parts, so that the metal powder suspension is arranged in the region of overlap between the at least two supply conductor parts which are to be joined to one another.

This ensures that the metal from the metal powder suspension is available as solder for the welding or soldering process at the location where the supply conductor parts are joined. The process according to the invention is less expensive and less complex than coating with the aid of a sputtering installation or a PVD coating apparatus (PVD stands for plasma vapor deposition), since it requires only partial coating of the supply conductor parts and does not necessitate one of the complex manufacturing facilities mentioned above.

It is preferable for the supply conductor part or parts with the applied metal powder suspension to be heated before the welding or soldering process until the solvent evaporates. The dried or sintered metal powder which remains is consequently securely bonded to the supply conductor part or parts. During the subsequent welding or soldering process, the metal powder melts in the region of the welding or soldering location and serves as a solder between the supply conductor parts that are to be joined, and also increases the resistance of the welding or soldering location to corrosion and oxidation. The metal powder which is bonded to the supply conductor part or parts outside the welding or soldering location increases the resistance of the supply conductor part or parts to corrosion and oxidation and prevents the quartz glass of the lamp vessel from adhering to the supply conductor part or parts embedded therein and also prevents cracks from forming in the quartz glass of the lamp vessel as a result of the extremely different coefficients of thermal expansion of quartz glass and supply conductor parts.

It is also possible for the supply conductor parts to be welded or soldered without prior evaporation of the solvent. The solvent is suddenly evaporated by short-time heating of the supply conductor parts. This ensures that atmospheric oxygen can gain access to the location of the join and also ensures good wetting of the parts to be joined by the liquid solder. This process can be carried out without shielding gas, whereas if evaporation of the solvent is employed prior to the welding or soldering process, it is necessary to use shielding gas, for example inert gas.

The platinum metal used for the metal powder suspension is preferably ruthenium, since it forms an alloy with molybdenum, which is preferably used for supply conductor parts of lamps. Therefore, the process according to the invention is particularly suitable for the production of supply conductors which include a molybdenum foil, as is customarily used to seal lamp vessels consisting of quartz glass, and a metal pin, in particular a molybdenum pin or a tungsten pin. After the welding or soldering process, that end of the above mentioned metal pin which overlaps the molybdenum foil is covered with a layer of ruthenium or a ruthenium alloy, in particular a ruthenium-molybdenum alloy. This layer increases the resistance of the welded or soldered join to corrosion and oxidation and reduces the formation of cracks in the lamp vessel in the region of the welded or soldered join when the supply conductor is embedded in the quartz glass of the lamp vessel.

In addition to ruthenium, the metal powder suspension preferably also contains molybdenum, which forms a eutectic alloy with a melting point of approx. 1900° C. with the ruthenium during the welding or soldering process, and this alloy is particularly advantageous for use as solder for the soldering of the abovementioned supply conductor parts.

### IV. DESCRIPTION OF THE PREFERRED EXEMPLARY EMBODIMENT

The invention is explained in more detail below on the basis of a preferred exemplary embodiment. In the drawings:

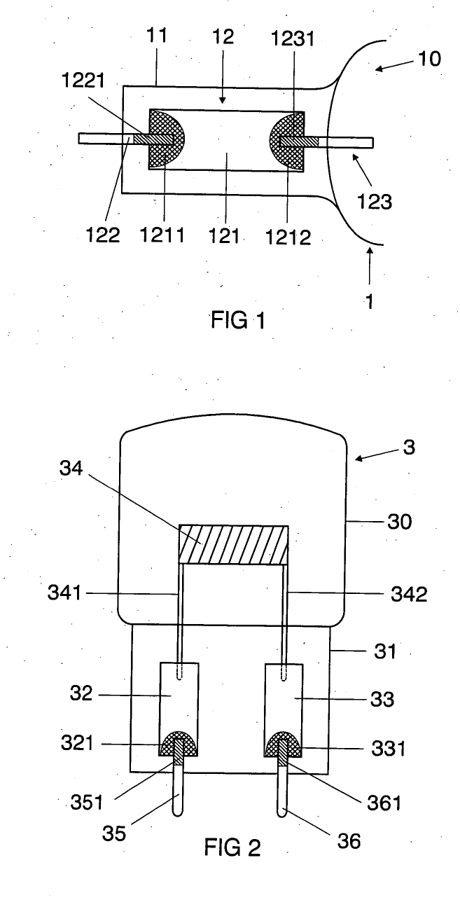

FIG. 1 shows a sealed end of a lamp vessel with the supply conductor in accordance with the first exemplary embodiment of the invention,

FIG. 2 shows a diagrammatic side view of an incandescent lamp with a lamp vessel sealed on one side and with supply conductors in accordance with the second exemplary embodiment of the invention.

### V. BEST MODE FOR CARRYING OUT THE INVENTION

FIG. 1 shows one sealed end 11 of a discharge vessel 1 which is sealed on two sides and the supply conductor 12 for a high-pressure discharge lamp for a motor vehicle headlamp in accordance with the first exemplary embodiment of the invention. The supply conductor 12 has a molybdenum foil 121 which is embedded in a gastight manner in the end 11. That end of the molybdenum foil 121 which is remote from the interior 10 of the discharge vessel 1 is welded to a molybdenum wire 122 which projects out of the sealed end 11. That end of the molybdenum foil 121 which faces the interior 10 of the discharge vessel 1 is welded to a rod-like electrode 123 consisting of tungsten, which projects into the discharge space 10. The length of the electrode 123 is 6.5 mm, and its thickness is 0.33 mm.

To produce the supply conductor 12, the molybdenum foil 121, which preferably consists of molybdenum doped with yttrium oxide, is welded or soldered to the molybdenum wire 122 and the electrode 123 before being embedded in the quartz glass of the discharge vessel 1. To solder the molybdenum foil 121 to the abovementioned supply conductor parts 122, 123, a drop of metal suspension which consists of ruthenium powder, molybdenum powder and the solvent terpineol is applied to each of the two ends of the molybdenum foil 121 in the region of the joining location. The grain size of the metal powder is in the range from approx. 10 μm to 70 μm, and the two metals ruthenium and molybdenum are mixed in the ratio of their eutectic. Then, the molybdenum foil 121 provided with the metal powder suspension is heated, so that the solvent terpineol evaporates and the mixture of ruthenium powder and molybdenum powder is dried and sintered on the surface of the molybdenum foil 121. As a result, the sintered metal powder 1211, 1212 is bonded to the surface of both ends of the molybdenum foil 121. The sintered metal powder 1211, 1212 is arranged on only one side of the molybdenum foil 121, namely on the side which is welded or soldered to the supply conductor parts 122, 123.

To weld or solder the molybdenum foil 121 to the molybdenum wire 122, the prefabricated molybdenum wire 122 is arranged so as to overlap the molybdenum foil 121, such that one of its ends rests on that surface of the molybdenum foil 121 which has been coated with the sintered metal powder 1211. Then, the two supply conductor parts 121, 122 in the region of overlap are heated by means of resistance heating until the metal powder 1211 which is bonded to the surface of the molybdenum foil in the region of overlap melts. The melting point of the metal powder is approx. 1900° C. The melt consisting of molybdenum-ruthenium alloy wets that end of the molybdenum wire 122 which overlaps the molybdenum foil 121 and also the molybdenum foil surface in the region in which it is being joined to the molybdenum wire 122. The molten metal powder serves as solder between the molybdenum wire 122 and the molybdenum foil 121. After the melt has cooled, that end of the molybdenum wire 122 which overlaps the molybdenum foil 121 has a coating 1221 of a ruthenium-molybdenum alloy.

The tungsten electrode 123 is also welded or soldered to the molybdenum foil 121 in a similar way to the molybdenum wire 122. To weld or solder the molybdenum foil 121 to the pin-shaped tungsten electrode 123, the prefabricated tungsten electrode 123 is arranged so as to overlap the molybdenum foil 121, such that its end 1231 rests on that surface of the molybdenum foil 121 which is coated with the sintered metal powder 1212. Then, the two supply conductor parts 121, 123 are heated in the region of overlap by means of resistance heating until the metal powder 1212 which is bonded to the surface of the molybdenum foil in the region of overlap melts. The melt consisting of molybdenum-ruthenium alloy wets that end of the tungsten electrode 123 which overlaps the molybdenum foil 121 and also the molybdenum foil surface in the region in which it is being joined to the tungsten electrode 123.

The molten metal powder serves as a solder between the tungsten electrode 123 and the molybdenum foil 121. After the melt has cooled, the end of the tungsten electrode 123 has a coating 1231 of a ruthenium-molybdenum alloy. The coating 1221 or 1231 may also extend onto that section of the molybdenum wire 122 or of the tungsten electrode 123 which does not overlap the molybdenum foil 121. The welding or soldering processes described above are preferably carried out under an inert gas atmosphere, for example an argon or forming gas atmosphere (hydrogen-nitrogen atmosphere).

The supply conductor 12 which has been prefabricated in this way, comprising the molybdenum wire 122, the molybdenum foil 121 and the tungsten electrode 123, is then introduced into the still-open end 11 of the discharge vessel 1. Then, the quartz glass of the end 11 is softened by heating and pinched tight over the molybdenum foil 121. After cooling, the end 11 is closed off in a gastight manner in the region of the molybdenum foil 121 between the tungsten electrode 123 and the molybdenum wire 122. The welded or soldered joins between the molybdenum foil 121 and the supply conductor wire 122 or the electrode 123 are reliably protected against corrosion by being coated with the ruthenium alloy which is formed during the process according to the invention. Moreover, the coating reduces bonding of the quartz glass to the supply conductor parts 122, 123. As a result, the formation of cracks in the quartz glass caused by the relatively high thermal expansion of the supply conductor parts 122, 123 is reduced. The other end (not shown) of the discharge vessel 1 of the high-pressure discharge lamp is formed identically to the end 11. A complete description of the high-pressure discharge lamp is disclosed in EP 1 465 236 A2.

FIG. 2 diagrammatically depicts a halogen incandescent lamp 3 in accordance with the second exemplary embodiment of the invention. The sealed end 31 of the lamp vessel 30 consisting of quartz glass is provided with two supply conductors produced in accordance with the invention for the incandescent filament 34 arranged within the lamp vessel 30. The two supply conductors each comprise a molybdenum foil 32 or 33 and a molybdenum wire 35 or 36 welded or soldered to it. Each of these supply conductors is welded to an outgoing part 341 or 342 of the incandescent filament 34. The welded or soldered join between that end 351 or 361 of the molybdenum wire 35 or 36 which overlaps the molybdenum foil 32 or 33 is produced in the same way as the welded or soldered join between the molybdenum foil 12 and the molybdenum wire 122 of the first exemplary embodiment. After the welded or soldered join has been produced, that end 351 or 361 of the molybdenum wire 35 or 36 which has been joined to the molybdenum foil 32 or 33 is coated with a ruthenium-molybdenum alloy. Outside the location of the join between molybdenum foil 32 or 33 and the molybdenum wire 35 or 36, the corresponding surface of the end 321 or 331 of the molybdenum foil 32 or 33 is coated with the sintered metal powder, similarly to the description of the first exemplary embodiment. In the region of the join between molybdenum foil 32 or 33 and the molybdenum wire 35 or 36, where the sintered metal powder has been melted during the welding or soldering process, there is a ruthenium-molybdenum alloy which serves as solder between the molybdenum wire 35 or 36 and the molybdenum foil 32 or 33. The outgoing parts 341, 342 of the incandescent filament 34 consisting of tungsten wire are each welded to a molybdenum foil 32 or 33. No solder is used for the welded join between the outgoing parts 341, 342 of the filament and the molybdenum foils 32, 33.

1. A process for producing a supply conductor, which is at least partially provided with a coating containing at least one platinum metal, for a lamp, in which process at least two supply conductor parts are joined to one another by a welded or soldered join to produce the supply conductor, wherein before the welded or soldered join is produced, a metal powder suspension which contains the at least one platinum metal is applied to at least one of the supply conductor parts, so that the metal powder suspension is arranged in the region of overlap between the at least two supply conductor parts.

2. The process as claimed in claim 1, wherein the at least one supply conductor part which has been provided with the metal powder suspension is heated before the welded or soldered join is produced, so that the solvent in the metal powder suspension is evaporated.

3. The process as claimed in claim 1, wherein the process is carried out using shielding gas or inert gas.

4. The process as claimed in claim 1, wherein the at least one platinum metal is ruthenium.

5. The process as claimed in claim 1, wherein a first one of the at least two supply conductor parts is in the form of a molybdenum foil.

6. The process as claimed in claim 5, wherein a second one of the at least two supply conductor parts is in the form of a metal pin.

7. The process as claimed in claim 6, wherein the metal pin is in the form of a molybdenum pin or a tungsten pin.

8. A supply conductor for a lamp, which has an at least partial coating containing at least one platinum metal, produced as described in claim 1.

9. A lamp having a luminous means surrounded by a lamp vessel and having at least one supply conductor for the luminous means as claimed in claim 7, which leads out of at least one sealed end of the lamp vessel.

10. The lamp as claimed in claim 9, wherein the at least one supply conductor comprises a molybdenum which is embedded in the sealed end of the lamp vessel and is joined to at least one metal pin, the metal pin and/or the molybdenum having an at least partial coating which is arranged in the region of overlap between the metal pin and molybdenum foil and contains ruthenium or a ruthenium alloy.

11. The lamp as claimed in claim 10, wherein at least that end of the metal pin which overlaps the molybdenum foil is provided with the coating.

12. The lamp as claimed in claim 10, wherein the metal pin is a tungsten electrode or a tungsten wire.

13. The lamp as claimed in claim 10, wherein the metal pin is a molybdenum wire.
